(19) United States
(12) Patent Application Publication
(10) Pub. No.: US 2011/0174649 A1
(43) Pub. Date: Jul. 21, 2011

(54) WET PACK BOX WITH TEAR OPEN FEATURE

(75) Inventor: Albert GARCIA, Miami, FL (US)

(73) Assignee: PASSION GROWERS LLC, MIAMI, FL (US)

(21) Appl. No.: 12/910,577

(22) Filed: Oct. 22, 2010

Related U.S. Application Data
(60) Provisional application No. 61/295,458, filed on Jan. 15, 2010.

(51) Int. Cl. B65D 85/50; B31B 1/60

(52) U.S. Cl. 206/423; 493/115

(57) ABSTRACT

Wet pack boxes are provided that include perforated first sides (which may be the front sides) for easy removal of the products contained therein. Wet pack boxes can be utilized for the shipment and transportation of floral products. The front face of the wet pack boxes can be in a closed position when a product is loaded therein, and can be opened by the exertion of force to tear the front face along the perforations to allow for removal of the product.

### FIELD

The present technology relates to wet pack boxes that can be utilized as packaging for the shipment and transportation of products, particularly fragile products that contain moisture, such as, floral products. More particularly, wet pack boxes of the present technology include at least one side that is perforated for easy removal of the products contained therein.

### BACKGROUND

The shipment and transport of bulk floral products from growers to distributors requires special handling in order to avoid damage of the products. Bulk floral products can include, for example, cut flowers, greenery, or other plant products. Cut flowers, for example, tend to be shipped in bulk as a collection of flowers that having their stems in a container such as a bucket. The stems of the flowers are generally surrounded by water, which can be contained in a bag that is within the bucket. The heads of the flowers generally protrude from the bucket.

Wet pack boxes are currently utilized to pack and ship bulk floral products. Wet pack boxes are generally fabricated from cardboard, such as corrugated cardboard, that can have a water resistant or water repellant coating on the inside surface of the package. Often, such boxes are assembled in such a way that they are left open at the top, the product is inserted into the box through the top opening, and then the top opening is closed and sealed. Upon delivery, a recipient can unseal the top of the box and remove the product through the top opening. However, flowers tend to be cut as buds, and can begin to open during shipment, thus expanding and becoming more fragile. Accordingly, distributors can damage the flower heads when they open the top of the wet pack box and reach down past the flower heads to grab the bucket to remove it from the wet pack box.

Another example of a wet pack box includes a perforation around the entire periphery of the sides of the box near the bottom. Upon delivery, the box can be torn along the perforation to completely remove the upper section of the box, leaving the product sitting on a base of the box.

### BRIEF DESCRIPTION OF SEVERAL VIEWS OF THE DRAWINGS

Specific examples have been chosen for purposes of illustration and description, and are shown in the accompanying drawings, forming a part of the specification.

FIG. 1 illustrates one example of a template for a wet pack box.

FIG. 2 illustrates an assembled wet pack box of FIG. 1 receiving a product.

FIG. 3 illustrates an assembled wet pack box of FIGS. 1 and 2 is in a closed position.

FIG. 4 illustrates an assembled wet pack box of FIGS. 1 through 3 in an open position.

FIG. 5 illustrates a second example of a template for a wet pack box.

### DETAILED DESCRIPTION

Wet pack boxes of the present technology can be utilized to contain products during shipment and transportation, particularly bulk floral products, such as cut flowers being shipped from a grower to a distributor. Wet pack boxes of the present technology include at least one side having perforations to accommodate opening of the wet pack box by tearing the side of the box along the perforations and then removing the product through the open side of the wet pack box.

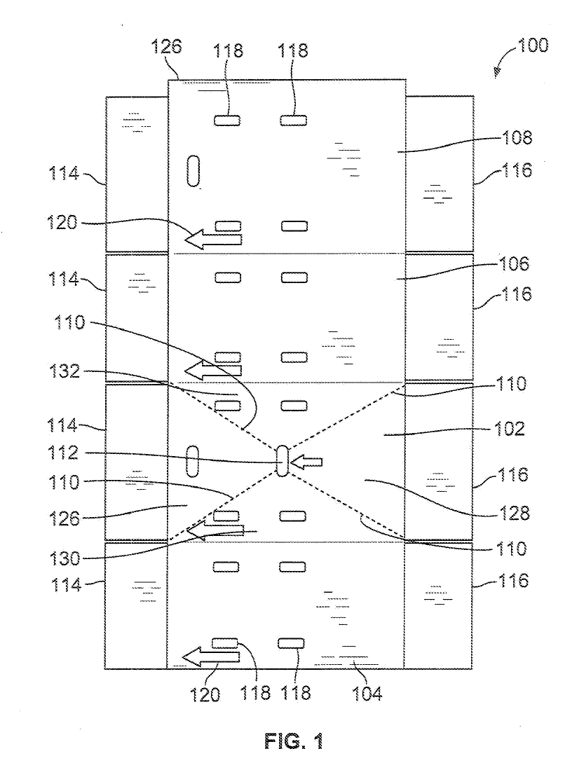

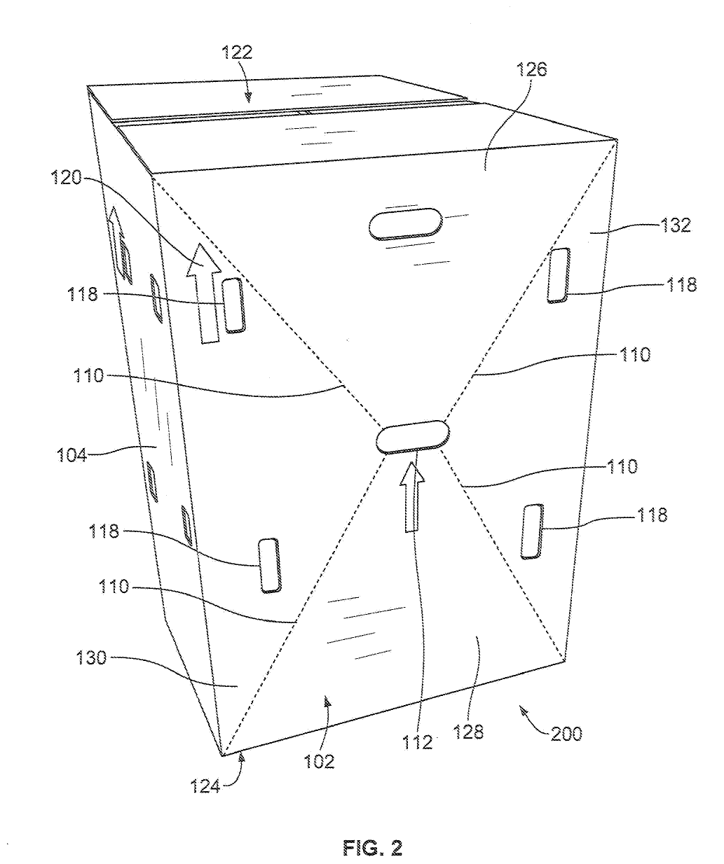

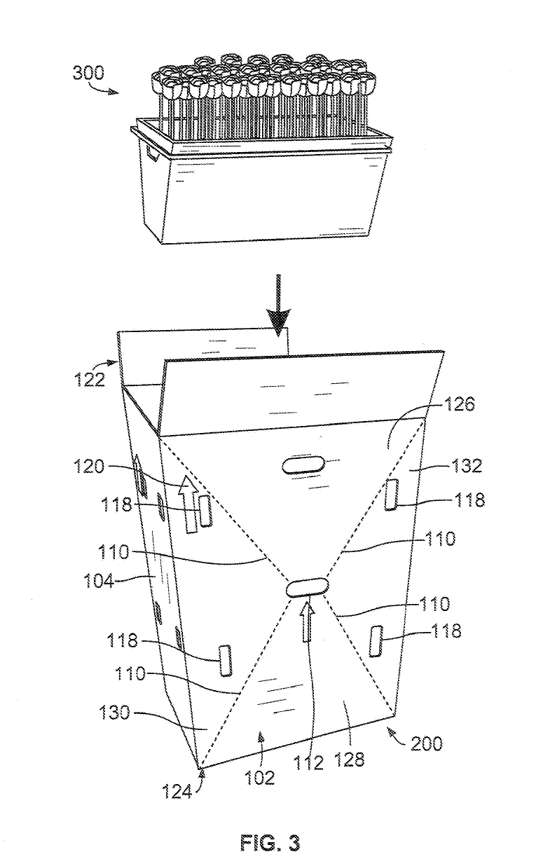

FIGS. 1 through 4 illustrate one example a wet pack box 100. FIG. 1 illustrates the template for the wet pack box, shown in a flattened, unassembled configuration. FIG. 2 illustrates the wet pack box in an assembled, upright, closed configuration, such as when the wet pack box is loaded with a product. FIG. 3 illustrates the wet pack box in an assembled, upright, open configuration, such as when the wet pack box has been opened to remove the product therefrom.

As shown in FIG. 1, wet pack box 100 has a plurality of sides, including a front side 102, a right side 104, a left side 106, and a back side 108. Each side, including the front side 102, can be substantially rectangular in shape, and can thus include a surface area having four corners. The front side 102 includes a plurality of perforations 110, and at least one finger hole 112. The finger hole 112 can be centrally located on the front side 102 of the wet pack box. The term “centrally located” should be understood to mean at or near the center with respect to both the horizontal and vertical dimensions of the front side 102. The finger hole 110 can be sized to receive one or more fingers on a human hand, and can be utilized to grip a portion of the front side 102 of the wet pack box and exert force to tear the front side 102 along the perforations 110. The perforations 104 can form any suitable path or pattern. As illustrated, the wet pack box 100 includes four perforations 110 that form an X shape on the front side 102 of the box. Each perforation 110 extends diagonally outward from the finger hole towards a corner of the front side 102 of the wet pack box 100. Each perforation can extend 100% of the distance from the finger hole to a corner of the front side 102, as shown in FIGS. 1 through 3, or can extend a portion of the distance from the finger hole 112 to any corner of the front side 102, including but not limited to at least about 50% of the distance, at least about 60% of the distance, at least about 70% of the distance, at least about 75% of the distance, at least about 80% of the distance, at least about 90% of the distance, at least about 91% of the distance, at least about 92% of the distance, at least about 93% of the distance, at least about 94% of the distance, at least about 95% of the distance, at least about 96% of the distance, at least about 97% of the distance, at least about 98% of the distance, or at least about 99% of the distance.

The wet pack box 100 also includes a plurality of top flaps 114 that form the top of the wet pack box 100 when it is assembled, and a plurality of bottom flaps 116 that form the bottom of the wet pack box 100 when it is assembled. Each side of the wet pack box 100 can include one or more vent holes 118, which can be located in or near the top half of the wet pack box 100 when it is assembled and standing upright. Vent holes 118 can permit airflow into and out of the wet pack box 100, which can provide oxygen to a product contained within the wet pack box 100. Vent holes 118 can be especially useful when the product in the wet pack box 100 is floral product, in order to facilitate maintenance of the freshness of the floral product. Each side of the wet pack box 100 can also include one or more indicia 120, such as, for example, an arrow pointing upwards towards the top flaps 114, indicating the location of the top of the wet pack box 100 when it is assembled and standing upright.

An assembled wet pack box 100, as shown in FIGS. 2 through 4, formed from a template as illustrated in FIG. 1 can generally include folding the wet pack box template to form a plurality of sides 102, 104, 106 and 108, a top 122 formed from top flaps 114, and a bottom 124 formed from bottom flaps 116. An edge of one side can be sealed to an edge of a second side, or to a portion of the second side near an edge thereof. As illustrated, back side 108 includes a tab 126 that can be sealed to the right side 104. The bottom 124 of the wet pack box 100 can also be sealed. The top 122 of the wet pack box 100 can initially be left open and unsealed to allow loading of a product into the wet pack box 100. Loading of a product can thus include inserting the product into the wet pack box 100 through the top 122 of the wet pack box 100. Once the product is loaded into the wet pack box, the top 122 of the wet pack box can be closed and sealed. Sealing the sides, the bottom 124, and the top 122 of the wet pack box 100 can be accomplished by any suitable means, including, for example, using an adhesive. Any suitable adhesive can be utilized, including, but not limited to, single sided tape, double sided tape, or glue.

The front side 102 of the wet pack box 100 is in a closed position when the wet pack box 100 is assembled, and remains closed when the product is loaded into the wet pack box 100, as illustrated in FIGS. 2 and 3. The perforations 110 are configured to allow the wet pack box 100 to be opened by tearing the front side 102 along the perforations. The perforations 110 divide the front side 102 of the wet pack box 100 into multiple front flaps. As illustrated, the perforations 110 divide the front side 102 into four front flaps, including an upper flap 126, a bottom flap 128, a first side flap 130 and a second side flap 132. The wet pack box 100 is thus openable by tearing the front side 102 along the perforations 110 and separating the front flaps, as illustrated in FIG. 3. When separating the front flaps, the front flaps can be folded or otherwise moved outwardly. Opening the wet pack box 100 can be accomplished by exerting force, such as manual force, to tear the front side 102 along the perforations 110.

In the illustrated example, the wet pack box 100 is openable without reducing the surface area of the front side 102, as would occur if all or a portion of any of the front flaps were to be removed from the wet pack box 100. Instead, a substantial portion of the surface area of the front side 102 is movable from a closed position to an open position upon separation of the perforations, which creates an opening through which the product contained in the wet pack box 100 can be accessed. The portion of the surface area of the front side 102 that is movable can be equal to or greater than about half of the surface area of the front side 102, including but not limited to being equal to or greater than about 60% of the surface area, equal to or greater than about 70% of the surface area, equal to or greater than about 75% of the surface area, equal to or greater than about 80% of the surface area, equal to or greater than about 90% of the surface area, equal to or greater than about 91% of the surface area, equal to or greater than about 92% of the surface area, equal to or greater than about 93% of the surface area, equal to or greater than about 94% of the surface area, equal to or greater than about 95% of the surface area, equal to or greater than about 96% of the surface area, equal to or greater than about 97% of the surface area, equal to or greater than about 98% of the surface area, equal to or greater than about 99% of the surface area, or equal to about 100% of the surface area.

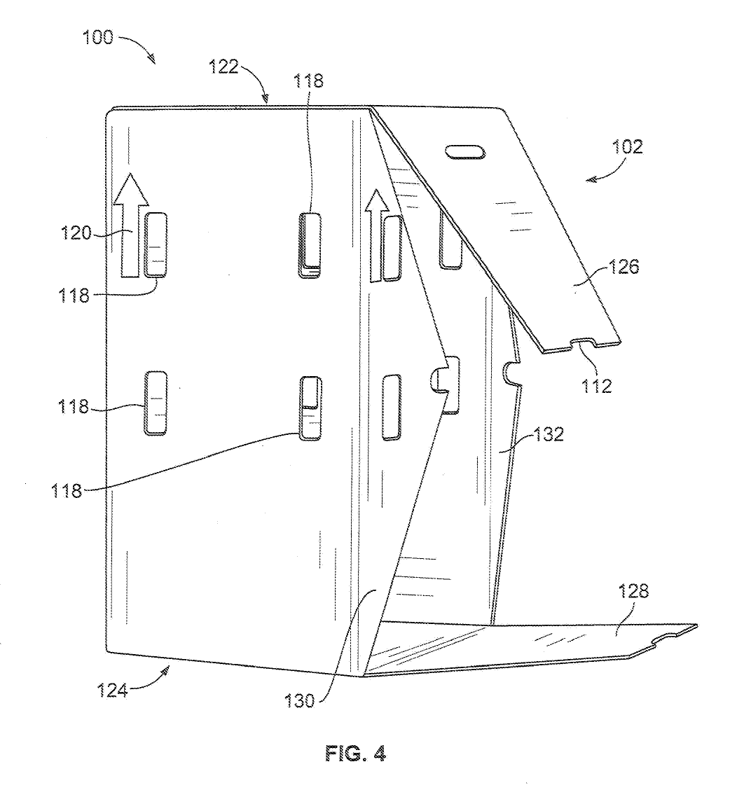

Unloading a product from the wet pack box 100 can include removing the product from the wet pack box 100 through the front side 102 of the wet pack box 100 when the front side 102 is opened, as illustrated in FIG. 4. The product can be oriented in the wet pack box 100 with the bottom of the product facing or adjacent to the bottom 124 of the box, and the top of the product facing the top 122 of the box. Accordingly, the indicia 120 on the sides of the wet pack box 100 can indicate the orientation of the top of the product as well as the top 122 of the box. The product can be configured and have dimensions suitable for allowing removal the product from the wet pack box 100. In examples where the product is floral product, it can be desirable to limit the extent to which the product must be tilted or twisted in order to remove it from the wet pack box 100. Therefore, the portion of the surface area of the front side 102 that is movable is preferably sufficient to allow removal of the product by tilting the product at an angle of less than or equal to about 45°.

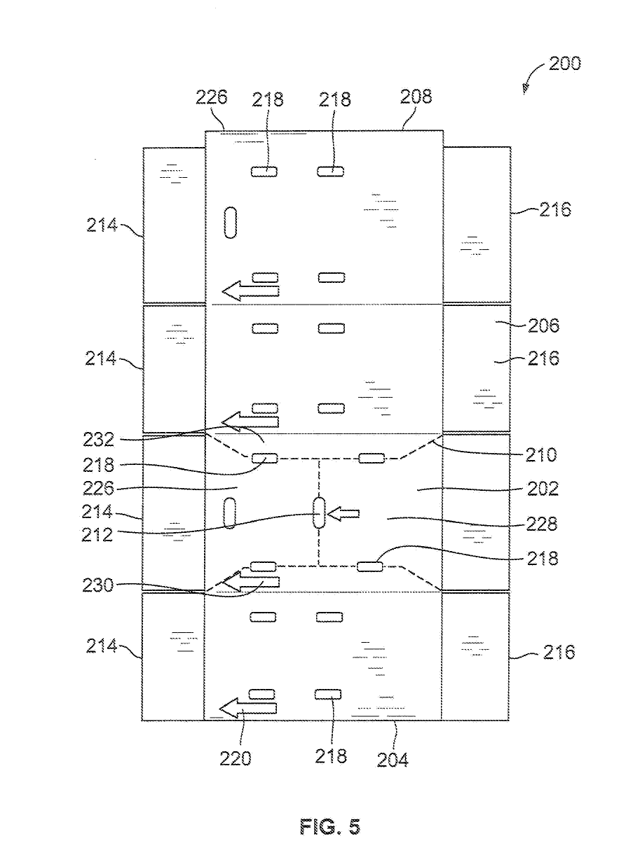

As shown in FIG. 5, wet pack box 200 has a plurality of sides, including a front side 202, a right side 204, a left side 206, and a back side 208. Each side, including the front side 202, can be substantially rectangular in shape, and can thus include a surface area having four corners. The front side 202 includes a plurality of perforations 210, and at least one finger hole 212. The finger hole 212 can be centrally located on the front side 202 of the wet pack box. The term “centrally located” should be understood to mean at or near the center with respect to both the horizontal and vertical dimensions of the front side 202. The finger hole 210 can be sized to receive one or more fingers on a human hand, and can be utilized to grip a portion of the front side 202 of the wet pack box and exert force to tear the front side 202 along the perforations 210. As illustrated, the wet pack box 200 includes four perforations 210 that form an H shape on the front side 202 of the box. The perforations 210 initially extend horizontally from the finger hole 212, and then extend vertically along the front side 102 of the box. The perforations 210 can continue to extend vertically towards the top and bottom edges of the front side 102, or, as illustrated, can extend vertically to an intermediate location on the front side 202 and then extend diagonally towards the corners of the front side. It is noted that perforations forming an H shape can be less preferred in applications where the wet pack boxes are formed by an automated process. It has been found that the structural integrity of the front side 102 can be reduced when perforations 212 extend vertically, parallel to the folds that form the vertical sides of the wet pack box 200, because the wet pack boxes can tend to bend or tear along the perforations 212 rather than along the nearby crease during formation of the wet pack box 200, especially when the box 200 is assembled using automated assembly equipment.

The wet pack box 200 also includes a plurality of top flaps 214 that form the top of the wet pack box 200 when it is assembled, and a plurality of bottom flaps 216 that form the bottom of the wet pack box 200 when it is assembled. Each side of the wet pack box 200 can include one or more vent holes 218, which can be located in or near the top half of the wet pack box 200 when it is assembled and standing upright. Vent holes 218 can permit airflow into and out of the wet pack box 200, which can provide oxygen to a product contained within the wet pack box 200. Vent holes 218 can be especially useful when the product in the wet pack box 200 is floral product, in order to facilitate maintenance of the freshness of the floral product. Each side of the wet pack box 200 can also include one or more indicia 220, such as, for example, an arrow pointing upwards towards the top flaps 214, indicating the location of the top of the wet pack box 200 when it is assembled and standing upright. Wet pack box 200 can be assembled, loaded, and unloaded in the same manner as described above with respect to wet pack box 100.

The perforations 210 are configured to allow the wet pack box 200 to be opened by tearing the front side 202 along the perforations. The perforations 210 divide the front side 202 of the wet pack box 200 into multiple front flaps. As illustrated, the perforations 210 divide the front side 202 into four front flaps, including an upper flap 226, a bottom flap 228, a first side flap 230 and a second side flap 232. The wet pack box 200 is thus openable by tearing the front side 202 along the perforations 210 and separating the front flaps. The wet pack box 200 is openable without reducing the surface area of the front side 202, as would occur if all or a portion of any of the front flaps were to be removed from the wet pack box 200. Instead, a substantial portion of the surface area of the front side 202 is movable from a closed position to an open position upon separation of the perforations, which creates an opening through which the product contained in the wet pack box 200 can be accessed. The portion of the surface area of the front side 202 that is movable can be equal to or greater than about half of the surface area of the front side 202, including but not limited to being equal to or greater than about 60% of the surface area, equal to or greater than about 70% of the surface area, equal to or greater than about 75% of the surface area, equal to or greater than about 80% of the surface area, equal to or greater than about 90% of the surface area, equal to or greater than about 91% of the surface area, equal to or greater than about 92% of the surface area, equal to or greater than about 93% of the surface area, equal to or greater than about 94% of the surface area, equal to or greater than about 95% of the surface area, equal to or greater than about 96% of the surface area, equal to or greater than about 97% of the surface area, equal to or greater than about 98% of the surface area, equal to or greater than about 99% of the surface area, or equal to about 100% of the surface area.

Wet pack boxes described herein can be fabricated from cardboard, and can be, for example, corrugated cardboard. The inside surface of the wet pack boxes can have a water resistant or water repellent coating. Perforations can be formed on the front side of a wet pack box by utilizing a cutting die, or any other suitable tool.

From the foregoing, it will be appreciated that although specific examples have been described herein for purposes of illustration, various modifications may be made without deviating from the spirit or scope of this disclosure. For example, although the perforations were formed in the front side in the embodiments discussed above, it should be understood that the above-described perforations can be formed in any side of the box, including the top and bottom. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A wet pack box comprising:
a plurality of sides including a first side, the first side being substantially rectangular in shape and including a surface area having four corners, a finger hole, and a plurality of perforations;
a top; and
a bottom;
wherein a substantial portion of the surface area of the first side is movable from a closed position to an open position upon separation of the perforations.

2. The wet pack box of claim 1, wherein the finger hole is centrally located on the first side of the wet pack box.

3. The wet pack box of claim 1, wherein the perforations each extend from the finger hole toward each corner of the first side.

4. The wet pack box of claim 3, wherein the perforations each extend at least about 50% of the distance from the finger hole to a corner of the first side.

5. The wet pack box of claim 3, wherein the perforations each extend at least about 75% of the distance from the finger hole to a corner of the first side.

6. The wet pack box of claim 1, wherein each side further comprises at least one vent hole.

7. The wet pack box of claim 1, wherein the wet pack box is openable by separation of the perforations without reducing the surface area of the first side.

8. The wet pack box of claim 1, wherein the portion of the surface area of the first side that is movable is equal to or greater than about half of the surface area of the first side.

9. The wet pack box of claim 1, wherein the portion of the surface area of the first side that is movable is equal to or greater than about 75% of the surface area of the first side.

10. A method of packaging products in a wet pack box, the method comprising the steps of:
assembling a wet pack box to form a top, a bottom, and plurality of sides including a first side, the first side being substantially rectangular in shape and including a surface area having four corners, a finger hole, and a plurality of perforations;
loading a product into the wet pack box by inserting the product through an opening at the top of the wet pack box; and
sealing the top of the wet pack box after the product is loaded;
wherein a substantial portion of the surface area of the first side is movable from a closed position to an open position upon separation of the perforations.

11. The method of claim 10, wherein an adhesive is used in sealing the top of the wet pack box.

12. The method of claim 10, wherein the finger hole is centrally located on the first side of the wet pack box.

13. The method of claim 10, wherein the perforations each extending from the finger hole toward each corner of the first side.

14. The method of claim 13, wherein the perforations each extend at least about 50% of the distance from the finger hole to a corner of the first side.

15. The method of claim 10, wherein each side further comprises at least one vent hole.

16. The method of claim 10, wherein the vent hole can be located in or near the top half of the side.

17. The method of claim 10, wherein the wet pack box is openable by separation of the perforations without reducing the surface area of the first side.

18. The method of claim 10, wherein the portion of the surface area of the first side that is movable is equal to or greater than about half of the surface area of the first side.

19. The method of claim 10, wherein the portion of the surface area of the first side that is movable is equal to or greater than about 75% of the surface area of the first side.

20. A method for opening a packaged floral product comprising the steps of:
inserting at least on finger into a finger hole formed in a first side of a box, the box having a top, a bottom, and plurality of sides including the first side, the first side being substantially rectangular in shape and including a surface area having four corners and a plurality of perforations formed therein;
tearing the first side along the perforations by exerting force on the first side via the finger hole such that portions of the first side become movable;
moving portions of the first side to form an opening in the first side; and
removing a floral product from an inside of the box through the opening formed in the first side.
